(19) United States
(12) Patent Application Publication
(10) Pub. No.: US 2015/0168181 A1
(43) Pub. Date: Jun. 18, 2015

(54) SYSTEMS AND METHODS FOR DISPLAYING A PROBE GAP VALUE ON A SENSOR SYSTEM

(71) Applicant: General Electric Company, Schenectady, NY (US)

(72) Inventors: Lysle Rollan Turnbeaugh, Minden, NV (US); Steven Thomas Clemens, Carson City, NV (US); Yancey Herve Mbolda, Gardnerville, NV (US)

(73) Assignee: General Electric Company, Schenectady, NY (US)

(21) Appl. No.: 14/133,247

(22) Filed: Dec. 18, 2013

(51) Int. Cl. G01D 7/00; G01B 21/16

(52) U.S. Cl. CPC G01D 7/005; G01B 21/16

(57) ABSTRACT

A system may include a probe that may generate an analog signal that corresponds to a distance between a tip of the probe and a component of a machine. The system may also include a processor that may determine the distance between the tip of the probe and the component based on the analog signal. The system may also include a display that may visually depict the distance between the tip of the probe and the component.

### BACKGROUND

The subject matter disclosed herein relates to displaying a visual representation of a distance between a probe and a component being monitored by the probe on a device coupled to the probe. More specifically, the subject matter disclosed herein relates to systems and methods for displaying a visual representation of a probe gap on a proximity sensor system that may be employed by a condition monitoring system.

Industrial monitoring systems, such as asset condition monitoring systems, generally provide monitoring capabilities for various types of mechanical devices and systems. For example, an industrial monitoring system may monitor one or more mechanical parameters of a gas turbine system. Here, for example, the industrial monitoring system may include a number of sensors (e.g., temperature sensors, pressure sensors, flow sensors, proximity sensors, and the like) disposed throughout the gas turbine system to measure various parameters associated with the gas turbine system.

In this manner, condition monitoring systems may provide users with valuable information regarding the health or condition of various machines employed in an industrial environment. Using the data received from the sensors disposed throughout a mechanical device or system, users of the condition monitoring systems may analyze the data using various tools provided by the condition monitoring systems. However, to ensure that accurate data is received from these sensors, the sensor may be placed at a certain position with respect to a component of the mechanical device or system being monitored. Accordingly, improved systems and methods for enabling a user to accurately position a sensor to maintain some distance from a mechanical device or system are desirable.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system may include a probe that may generate an analog signal that corresponds to a distance between a tip of the probe and a component of a machine. The system may also include a processor that may determine the distance between the tip of the probe and the component based on the analog signal. The system may also include a display that may visually depict the distance between the tip of the probe and the component.

In another embodiment, an apparatus includes a method that may include receiving, via a processor, a feedback signal associated with energy emitted by a probe and reflected off a component of a machine. The method may then include determining a distance between a tip of the probe and the component. After determining the distance, the method may then send one or more signals to a display to illuminate one or more light sources based on the distance.

In yet another embodiment, a system may include a machine that may perform one or more industrial processes and a condition monitoring system that may monitor one or more components of the machine. The condition monitoring system may include a proximity sensor system that may include a probe and a display. The proximity sensor system may measure a distance between a tip of the probe and one of the components via the probe, and the display may depict a visual representation of the distance.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an industrial monitoring system, in accordance with embodiments presented herein;

FIG. 2 illustrates a block diagram of a proximity sensor system that may be employed in the industrial monitoring system of FIG. 1, in accordance with embodiments presented herein;

FIG. 3 illustrates a front view of one embodiment of the proximity sensor system of FIG. 2, in accordance with embodiments presented herein;

FIG. 4 illustrates a perspective view of one embodiment of the proximity sensor system of FIG. 2 coupled to a DIN-rail, in accordance with embodiments presented herein; and

FIG. 5 illustrates a front view of one embodiment of the proximity sensor system of FIG. 2 coupled to rack mount, in accordance with embodiments presented herein.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In an industrial environment, a number of machines may be operating together to perform various tasks related to gasifying a feedstock to produce syngas and/or chemicals, generating power for distribution on a power grid, operating turbine systems, mass producing a product, processing certain chemicals, and the like. Generally, a sensor system may be coupled to each of the machines in the industrial environment to monitor various conditions within a respective machine. For example, a plurality of sensors may be distributed in a gasification system, a turbine system, and/or a power plant to monitor temperatures, pressures, flow rates, gas compositions, vibration, clearance, torque, rotational speed, exhaust emissions, power output, flame characteristics, combustion dynamics, current, voltage, or any combination thereof. The sensor system may include a probe that may receive raw data associated with the condition being monitored. As such, the probe may be routed to a particular component or part of a machine, such that the sensor system may monitor various conditions related to the corresponding part or component of the machine. In order for the probe to perform its respective function, an end or tip of the probe may be positioned a certain distance away from the component or part of the machine being monitored. That is, the probe may use the empty space between its tip and the component being monitored to acquire raw data related to its respective function.

For example, in a generator, a probe may be routed to a piece or component of the generator, such that the probe may measure an amount of vibration that may be occurring on the component. To accurately measure the amount of vibration occurring on the component, the probe may use a certain amount of open space between the probe and the component to receive and/or generate data associated with the vibration properties of the component. As such, it is generally desirable to ensure that the tip of the probe is positioned at the certain distance, within a certain range of values, away from the component. In one embodiment, to ensure that the tip of the probe is positioned within the certain range of distances away from the component, the sensor system that may include a display that may provide a visual representation of a distance between the tip of the probe and a corresponding component being monitored. By providing the visual representation of the distance between the tip of the probe and the component being monitored on the display of the sensor system, the sensor system may enable a user installing the probe to position the tip of the probe at an appropriate distance away from the component being monitored. As a result, the probe may be effectively installed to accurately receive measurements regarding a respective component by the probe and to avoid problems that may occur with regard to those measurements when the probe is positioned too close to or too far from the respective component.

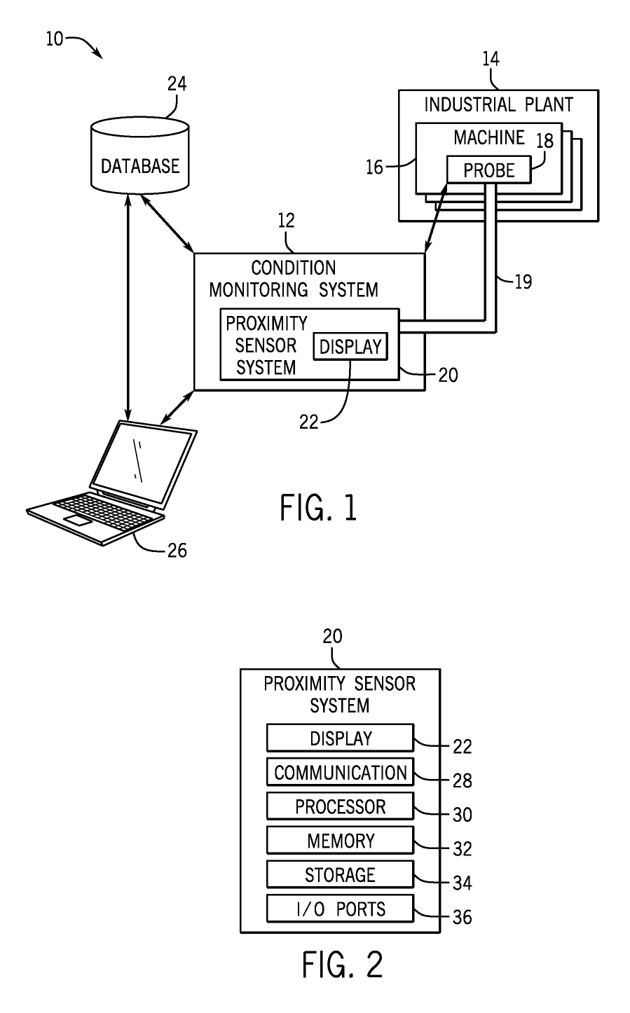

By way of introduction, FIG. 1 illustrates a block diagram of an industrial monitoring system 10 in which various types of machines used for industrial processes may be monitored. The industrial monitoring system 10 may include a condition monitoring system 12, which may monitor various components and devices used in an industrial plant 14. For instance, the condition monitoring system 12 may receive data from various machines 16 that may be part of an industrial plant 14. The industrial plant 14 may include any type of industrial environment where different machines 16 may be used to complete one or more industrial processes. As such, the industrial plant 14 may correspond to an oil refinery, a manufacturing facility, a turbo-machine system, a power generation system, a gasification system, a chemical production system, a gas turbine system, a steam turbine system, a combined cycle system, a power plant, or the like.

The machines 16 in the industrial plant 14 may include devices such as a gasifier, a gas treatment unit, an electric motor, a combustion engine, a gas turbine, a hydraulic turbine, a heat exchanger, centrifugal pumps, reciprocating pumps, centrifugal compressors, fans, reciprocating compressors, generators, steam turbines, wind turbines, piping, axial compressors, screw compressors, gears, turbo-expanders, blowers, agitators, mixers, centrifuges, pulp refiners, ball mills, crushers, pulverizers, extruders, pelletizers, cooling towers, boilers, furnaces, heat recovery steam generators (HRSGs), and the like. Each machine 16 may include one or more probes 18 that may monitor various components of a respective machine 16.

The probes 18 may include temperature sensors, current sensors, voltage sensors, pressure sensors, displacement sensors, velocity sensors, acceleration sensors, flow sensors, clearance sensors, flame sensors, gas composition sensors, vibration sensors, gas composition sensors, speed sensors, emissions sensors, and any other type of sensor that may provide information with respect to the respective component being monitored by the respective probe 18. As such, the probes 18 may be used to measure various properties (e.g., vibration) regarding the component being monitored.

Generally, the probes 18 may be physically routed from the condition monitoring system 12 through the respective machine 16 to the component in the respective machine 16 being monitored via a cable 19. In one embodiment, the probe 18 may include a sensor that may detect a presence or distance of a nearby component without physically contacting the component. For example, the probe 18 may emit radio frequency waves, electromagnetic waves, and the like to generate some feedback energy that reflects off of the component being monitored. The feedback energy may then be used to determine a distance between the tip of the probe 18 and the component.

In one specific example, the probe 18 may emit an electromagnetic field or a beam of electromagnetic radiation (e.g., infrared) towards the component being monitored. The probe 18 may then receive a feedback signal due to the emitted fields or radiation reflecting off of the component being monitored. The raw data representing the feedback signal may be transmitted via the cable 19 to a proximity sensor system 20, which may be part of the condition monitoring system 12. In one embodiment, the proximity sensor system 20 may analyze changes in the feedback signal to determine a distance between the tip of the probe 18 and the component being monitored. Additional details regarding the proximity sensor system 20 will be discussed below.

To determine the distance between the probe 18 and different types of components being monitored, the probe 18 may use different types of sensors. For example, a capacitive photoelectric sensor may be suitable for a plastic component, while an inductive proximity sensor may be suitable for a metal component.

As mentioned above, the probe 18 may be coupled to the proximity sensor system 20 via the cable 19. The proximity sensor system 20 may include circuitry that may be used to interpret raw data received via the probe 18, such as temperature, current, voltage, pressure, displacement, velocity, acceleration, flow, clearance, flame, gas composition, vibration, gas composition, speed, emissions, and any other type of data related to the respective component being monitored by the probe 18. As such, the proximity sensor system 20 may convert raw data into a desired or understandable format, which may then be provided to the condition monitoring system 12, another computing system, and the like. In addition to interpreting data associated with various properties monitored by the probe 18, the proximity sensor system 20 may also provide an output voltage that may be directly proportional to a distance between the tip of the probe 18 (i.e., probe tip) and the component being monitored.

In one embodiment, the proximity sensor system 20 may include a display 22 that may provide a visual representation of the distance or gap between the tip of the probe 18 and the component being monitored. As such, users of the proximity sensor system 20 may use the display 22 to determine the distance or gap between the tip of the probe 18 and the component being monitored. That is, in order for the probe 18 to effectively measure various properties related to the component being monitored, the tip of the probe 18 may use a certain amount of open space between the tip of the probe 18 and the component being monitored to perform its respective function. However, given the intricacies of the inner workings of the machine 16, it may be difficult for a user to be physically positioned within a respective machine 16 to determine whether the tip of the probe 18 is positioned at a sufficient distance away from the component. Keeping this in mind, the display 22 may provide a visual representation of the distance between the tip of the probe 18 and the component being monitored. As such, the user may use the display 22 to properly position the tip of the probe 18, such that the probe 18 may acquire data related to the function of the probe 18. In this manner, the user may properly position the tip of the probe 18 without being physically located adjacent to the tip of the probe 18.

The proximity sensor system 20 may send data related to the properties of the component being monitored or the position of the probe 18 to the condition monitoring system 12. In addition to data acquired by the probe 18, the condition monitoring system 12 may receive data from a database 24, which may be stored within or external to the condition monitoring system 12, in a server, in a cloud-computing device, or the like. The database 24 may include historical data related to the data acquired by the probe 18 or other contextual data related to the industrial plant 14, the machine 16, or the component being monitored.

Further, the condition monitoring system 12 and the database 24 may be communicatively coupled to a computing device 26 via a wired or wireless connection. As such, the computing device 26 may receive the data acquired and analyzed by the condition monitoring system 12. The computing device 26 may include other control or monitoring systems disposed in the same industrial plant 14 or another industrial plant 14.

Although FIG. 1 has been described with respect to the industrial plant 14, it should be noted that the systems and techniques described herein may be applied to other systems outside of the industrial environment. That is, the systems and techniques described herein should not be limited to industrial environments and the like.

As mentioned above, the probe 18 may transmit raw data related to the distance between the tip of the probe 18 and the component being monitored or may transmit data related to a monitored characteristic (e.g., vibration) of the component to the proximity sensor system 20. In certain embodiments, the proximity sensor system 20 may include certain components that may enable it to analyze the raw data and visually display the distance between the tip of the probe 18 and the component being monitored.

Keeping the foregoing in mind, FIG. 2 illustrates a block diagram of some example components that may be part of the proximity sensor system 20. As shown in FIG. 2, the proximity sensor system 20 may include a display 22, a communication component 28, a processor 30, a memory 32, a storage 34, input/output (I/O) ports 36, and the like. The communication component 28 may be a wireless or wired communication component that may facilitate communication between the proximity sensor system 20, the condition monitoring system 12, the machines 16, the database 24, the computing device 26, and the like.

The processor 30 may be any type of computer processor or microprocessor capable of executing computer-executable code. The memory 32 and the storage 34 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 30 to, among other things, analyze data received via the probe 14. The non-transitory computer-readable media merely indicates that the media is tangible and not a signal.

The display 22 may include any type of display device including light indicators, liquid crystal displays, a touch screen display device that may receive user inputs via the display device itself, and the like. In certain embodiments, the display 22 may interact with the processor 30 to visually indicate a distance between the tip of the probe 18 and a component being monitored. The display 22 may be directly disposed on a surface of a module or structure that may enclose or include the proximity sensor system 20. For example, the display 22 may be disposed on a surface of a DIN-rail mountable module that may enclose the proximity sensor system 20, a rack mountable computing card that may include the proximity sensor system 20, or the like. In one embodiment, the display 22 may include a fixed layout of light sources, such as light-emitting diodes and the like.

The I/O ports 36 may include an interface that may receive the cable 19, which may be coupled to the probe 18. As such, the proximity sensor system 20 may receive raw data acquired by the probe 18 via the I/O ports 36. In one embodiment, the proximity sensor system 20 may allow for limited or no input by a user. That is, the proximity sensor system 20 may be a device that couples directly to the probe 18 via the cable 19 but may not allow a user to directly input into the device. As such, the user may communicate with the proximity sensor system 20 via the condition monitoring system 12 or some other computer system.

As mentioned above, the raw data received from the probe 18 may include a feedback signal based on the energy (e.g., radio frequency, electromagnetic, etc.) emitted from the probe 14. The feedback signal may be an analog signal that may represent raw-non-linearized data of a peak-to-peak amplitude of the signal received by the probe 18. Here, the analog signal may represent the distance between the tip of the probe 18 and the component being monitored. In one embodiment, the processor 30 may receive the analog signal from the probe 18 via one or more of the I/O ports 36. After receiving the analog signal, the processor 30 may convert the analog signal into a digital signal using an analog-to-digital converter. The processor 30 may then linearize the digital signal, such that each value change in the digital signal may represent a unit or a portion of a unit of distance. By digitizing and linearizing the analog signal, the processor 30 may filter the analog signal to obtain a gap value. The gap value may correspond to a direct current (DC) offset of the analog signal. Moreover, the gap value may represent the distance between the tip of the probe 18 and the component.

Using the gap value or the DC offset of the analog signal, the processor 30 may determine the distance between the tip of the probe 18 and the component. The processor 30 may then send a signal indicating distance between the tip of the probe 18 and the component to the display 22. The display 22 may then present a visual representation of the distance between the tip of the probe 18 and the component.

The visual representation of the distance may be depicted by the display 22 in a number of ways. FIG. 3, for example, illustrates one embodiment of a front view 40 of the display 22 having a visual representation of the distance between the tip of the probe 18 and the component. As shown in FIG. 3, in one embodiment, the display 22 may include a light indicator 42, a light indicator 44, and a light indicator 46. The light indicators 42, 44, and 46 may be any type of light source such as a light-emitting diode or the like. In one embodiment, the light indicator 42 may be illuminated when the gap value is greater than a high gap value threshold. Here, the illuminated light indicator 42 may indicate that the tip of the probe 18 is too close to the component.

The light indicator 46 may be illuminated when the gap value is lower than a low gap value threshold. Here, the illuminated light indicator 46 may indicate that the tip of the probe 18 is too far from the component. The light indicator 44 may then be illuminated when the gap value is between the high gap threshold and the low gap threshold. As such, the tip of the probe 18 may be positioned at a sufficient distance away from the component, such that the probe 18 may perform one of its respective functions.

Although the display 22 is depicted in FIG. 3 with light indicators 42, 44, and 46, it should be noted that the distance between the tip of the probe 18 and the component may be depicted on the display 22 in a number of ways. In one example, the display 22 may include a multi-color light source (e.g., light-emitting diode) that may change colors based on the distance between the tip of the probe 18 and the component. That is, when the distance between the tip of the probe 18 and the component is less than the low gap value threshold, the multi-color light source may be illuminated with a first color (e.g., red). In the same manner, when the distance between the tip of the probe 18 and the component is greater than the high gap threshold, the multi-color light source may be illuminated with a second color (e.g., yellow). However, when the distance between the tip of the probe 18 and the component is between the high threshold and the low threshold, the multi-color light source may be illuminated with a third color (e.g., green).

In another example, the display 22 may include a light source that remains solid or is continuously illuminated when the distance between the tip of the probe 18 and the component is between the high gap threshold and the low gap threshold. However, when the distance between the tip of the probe 18 and the component is not between the high gap threshold and the low gap threshold, the light source may turn off and on or oscillate (i.e., blink). In certain embodiments, a frequency at which the light source oscillates may be directly related to a location of the tip of the probe 18 with respect to a range of desired distance values between the tip of the probe 18 and the component. That is, the light source may blink more frequently as the tip of the probe 18 moves closer to fit within a range of desired distances between the tip of the probe 18 and the component.

In yet another example, the display 22 may depict text providing instructions for the user with regard to the positioning of the tip of the probe 18 with respect to the component. That is, when the distance between the tip of the probe 18 and the component is above the high gap threshold, the display 22 may depict text instructing the user to move the probe 18 away from the component. In the same manner, when the distance between the tip of the probe 18 and the component is below the low gap threshold, the display 22 may depict text instructing the user to move the probe 18 closer to the component. When the distance between the tip of the probe 18 and the component is between the low gap threshold and the high gap threshold, the display 22 may depict text instructing the user to stop moving the probe 18 or that the probe 18 is positioned correctly.

In yet another example, the display 22 may include a gauge or meter that indicates whether the distance between the tip of the probe 18 and the component is between the low gap threshold and the high gap threshold. The display 22 may also display a number representing the distance between the tip of the probe 18 and the component when it is between the low gap threshold and the high gap threshold.

In yet another example, the display 22 may also include a horizontal bar that includes a number of light sources. Here, the center light sources of the horizontal bar may be illuminated when the distance between the tip of the probe 18 and the component is between the low gap threshold and the high gap threshold. In the same manner, the light sources located on either end of the horizontal bar may be illuminated when the distance between the tip of the probe 18 and the component is below the low gap threshold and above the high gap threshold, respectively.

In addition to depicting the distance between the tip of the probe 18 and the component, the display 22 may provide information related to a measurement or property sensed by the probe 18. For example, the probe 18 may measure radial vibration, radial position, axial position, eccentricity, 1× vibration amplitude, 1× vibration phase, 2× vibration amplitude, 2× vibration phase, n× vibration amplitude, n× vibration phase, not 1× vibration amplitude, temperature, position, velocity, acceleration, process variable value, and the like. In certain embodiments, the proximity sensor system 20 may then present the raw measurement data sensed by the probe 18 on the display 22. The proximity sensor system 20 may also analyze the raw measurement data and present the analyzed data on the display 22, such that a user may perform various job functions based on the analyzed data.

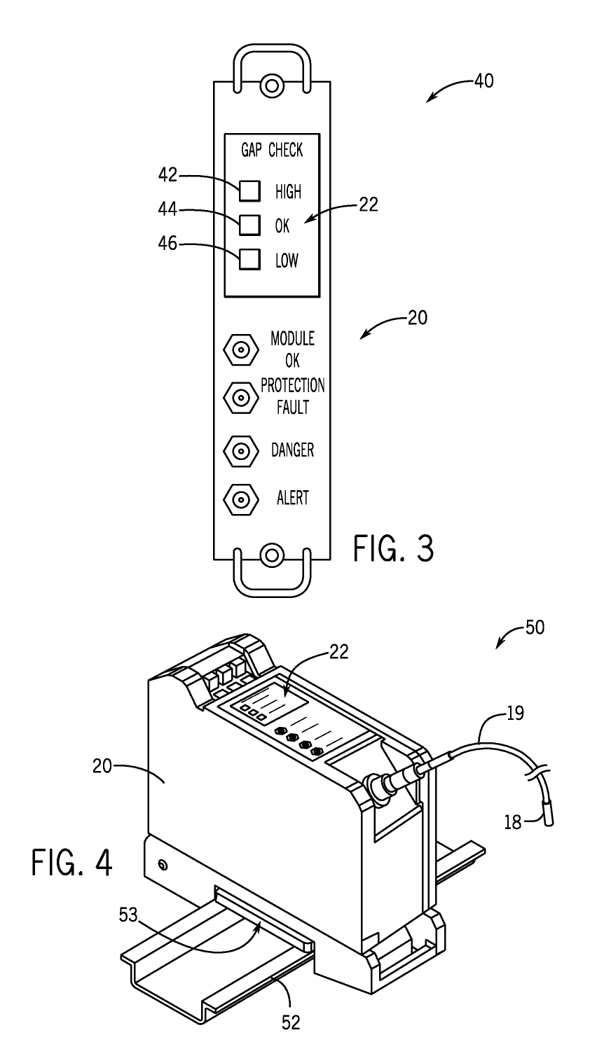

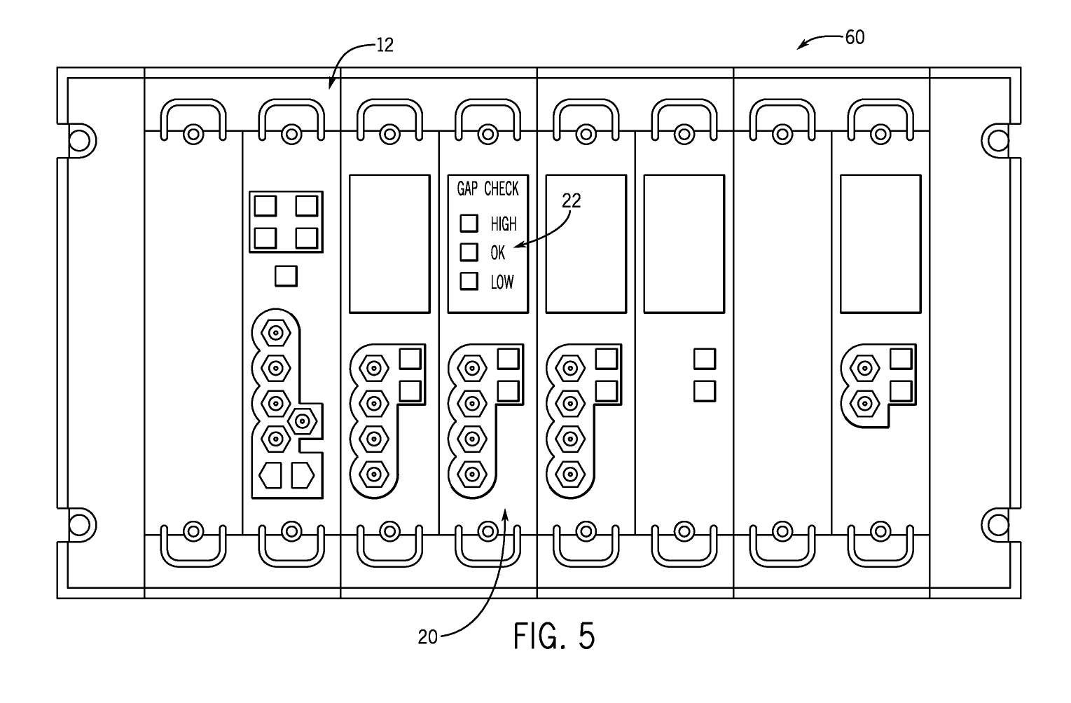

Keeping the foregoing in mind, FIG. 4 and FIG. 5 illustrate two embodiments in which the proximity sensor system 20 described above may be implemented. For example, FIG. 4 illustrates a perspective view 50 of the proximity sensor system 20 in a modular form coupled to a DIN-rail 52. As shown in FIG. 4, the display 22 may be disposed on a surface of the proximity sensor system 20 on an opposite side of a rail mount 53, where the proximity sensor system 20 may mount to the DIN-rail 52. As such, a user may easily view the display 22 when the proximity sensor system 20 is mounted on the DIN-rail 52. Moreover, the user may use the display 22 to accurately position the tip of the probe 18 with respect to the component when the proximity sensor system 20 is installed in a power cabinet or the like.

The proximity sensor system 20 may also be a rack-mountable computer card that may be part of the condition monitoring system 12. For instance, FIG. 5 illustrates a front view 60 of the proximity sensor system 20 coupled to computer card rack system. As shown in FIG. 5, the display 22 may be disposed on the surface of the proximity sensor system 20, such that the display 22 may be visible to the user when the proximity sensor system 20 is mounted in the computer card rack system. In this manner, the user may use the display 22 to accurately position the tip of the probe 18 with respect to the component when the proximity sensor system 20 is installed in computer card rack system.

Technical effects of the invention include providing a visual representation of the distance between the end of the probe and the respective component being monitored on a display of a sensor system. As a result, the sensor system may enable a user installing the probe to position the end of the probe at an appropriate distance away from the component being monitored. The probes may thus be installed more efficiently to more effectively receive measurements related to the component being monitored. Moreover, problems due to the position of the probe being too close or too far away from the respective component may be avoided.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a probe configured to generate an analog signal that corresponds to a distance between a tip of the probe and a component of a machine;
a processor configured to determine the distance between the tip of the probe and the component based on the analog signal; and
a display configured to visually depict the distance between the tip of the probe and the component.

2. The system of claim 1, wherein the display is configured to display data associated with one or more properties measured by the probe.

3. The system of claim 1, wherein the processor is configured to determine the distance between the tip of the probe and the component by:
receiving the analog signal via the probe;
converting the analog signal into a digital signal; and
linearizing the digital signal to generate a linearized digital signal, wherein each unit of the linearized digital signal represents an amount of distance between the tip of the probe and the component.

4. The system of claim 1, wherein the display comprises a first light indicator, a second light indicator, and a third light indicator, wherein the first light indicator is illuminated when the distance is greater than a high threshold, wherein the second light indicator is illuminated when the distance is lower than a low threshold, and wherein the third light indicator is illuminated when the distance is between the low threshold and the high threshold.

5. The system of claim 4, wherein each of the first light indicator, the second light indicator, and the third light indicator comprises a light-emitting diode.

6. The system of claim 1, wherein the display comprises a multi-color light source, wherein the multi-color light source is illuminated to a first color when the distance is greater than a high threshold, wherein the multi-color light source is illuminated to a second color when the distance is lower than a low threshold, and wherein the multi-color light source is illuminated to a third color when the distance is between the low threshold and the high threshold.

7. The system of claim 1, wherein the display comprises a light source configured to illuminate when the distance is between a low threshold and a high threshold.

8. The system of claim 1, wherein the display comprises a light source configured to oscillate on and off according to a frequency when the distance is less than a low threshold or greater than a high threshold.

9. The system of claim 8, wherein the frequency is determined based on a function of a location of the tip of the probe and any value in a range of desired distances between the tip of the probe and the component.

10. The system of claim 8, wherein the probe is configured to measure a radial vibration of the component, a radial position of the component, an axial position of the component, eccentricity of the component, a 1× vibration amplitude of the component, a 1× vibration phase of the component, a 2× vibration amplitude, a 2× vibration phase of the component, a n× vibration amplitude of the component, a n× vibration phase of the component, a temperature of the component, a position of the component, a velocity of the component, an acceleration of the component, a process variable value of the component, or any combination thereof.

11. A method, comprising:
receiving, via a processor, a feedback signal associated with energy emitted by a probe and reflected off a component of a machine;
determining a distance between a tip of the probe and the component; and
sending one or more signals to a display to illuminate one or more light sources based on the distance.

12. The method of claim 11, wherein energy emitted by the probe comprises radio frequency energy or electromagnetic energy.

13. The method of claim 11, wherein determining the distance comprises:
converting the feedback signal into a digital signal;
linearizing the digital signal to generate a gap value, wherein the gap value comprises a direct current (DC) offset of the feedback signal; and
determining the distance based on the gap value.

14. The method of claim 11, wherein sending the one or more signals to the display to illuminate the one or more light sources comprises:
illuminating a first light source when the distance is greater than a high threshold;
illuminating a second light source when the distance is lower than a low threshold; and
illuminating a third light source when the distance is between the low threshold and the high threshold.

15. The method of claim 11, wherein sending the one or more signals to the display to illuminate the one or more light sources comprises:
illuminating a first light source when the distance is between a low threshold and a high threshold; and
oscillating an illumination of the first light source on and off according to a variable frequency when the distance is less than the low threshold or greater than the high threshold.

16. A system, comprising:
a machine configured to perform one or more industrial processes;
a condition monitoring system configured to monitor one or more components of the machine, wherein the condition monitoring system comprises:
a proximity sensor system, comprising:
a probe configured to generate a signal that represents a distance between a tip of the probe and one of the components; and
a display configured to depict a visual representation of the distance.

17. The system of claim 16, wherein the proximity sensor system comprises a rail mount configured to mount onto a DIN-rail.

18. The system of claim 16, wherein the proximity sensor system comprises a rack mount configured to mount onto a computer rack.

19. The system of claim 16, wherein the machine comprises a motor, a gas turbine, a hydraulic turbine, a heat exchanger, a pump, a compressor, a fan, a generator, a steam turbine, a wind turbine, piping, a gear, a turbo-expander, a blower, an agitator, a mixer, a centrifuge, a pulp refiner, a ball mill, a crusher, a pulverizer, an extruder, a pelletizer, a cooling tower, or any combination thereof.

20. The system of claim 16, wherein the probe is configured to measure one or more properties associated with the one of the components, and wherein the display is configured to visually depict the one or more properties.
